(19) United States
(12) Patent Application Publication
(10) Pub. No.: US 2020/0404212 A1
(43) Pub. Date: Dec. 24, 2020

(54) BIDIRECTIONAL VIDEO COMMUNICATION SYSTEM AND OPERATOR TERMINAL

(71) Applicant: PANASONIC INTELLECTUAL PROPERTY MANAGEMENT CO., LTD., Osaka (JP)

(72) Inventors: Kazuyuki HORIO, Tokyo (JP); Issei IKEZAKI, Fukuoka (JP)

(73) Assignee: PANASONIC INTELLECTUAL PROPERTY MANAGEMENT CO., LTD., Osaka (JP)

(21) Appl. No.: 16/975,570

(22) PCT Filed: Feb. 7, 2019
(86) PCT No.: PCT/JP2019/004504

§ 371 Date: Aug. 25, 2020

(30) Foreign Application Priority Data
Feb. 26, 2018 (JP) 2018-032222

(51) Int. Cl. H04N 5/445; H04N 7/14; G06K 9/00; H04N 7/025; H04N 5/272; H04N 5/262; G06F 21/62

(52) U.S. Cl. CPC H04N 5/445; H04N 7/147; H04N 7/142; G06K 9/00295; G08B 21/02; H04N 5/272; H04N 5/2628; G06F 21/629; H04N 7/0255

(57) ABSTRACT

In order to enable a user operating a kiosk terminal to focus on the operation of the kiosk terminal while virtually eliminating any concerns about prying eyes, a controller of an operator terminal is configured such that, when a communication device receives a frontal-face video of the user, the frontal-face video being shot by a camera of the kiosk terminal such that the frontal-face video includes a background of the user, the controller displays the frontal-face video of the user on a monitor. The controller also performs face authentication on a person in the frontal-face video of the user, and upon detecting a suspicious person through the face authentication, the controller generates a screen in which identification information distinguishably identifying the user and the suspicious person has been added to the frontal-face video of the user, and displays the screen on the monitor.

### TECHNICAL FIELD

The present invention relates to a bidirectional video communication system for bidirectional communication between a kiosk terminal and an operator terminal, the system being configured for bidirectional transmission of a video of a user who operates the kiosk terminal and a video of an operator who operates the operator terminal, and an operator terminal used therein.

### BACKGROUND ART

In recent years, kiosk terminals are widely used for providing services such as guidance services (providing various types of information) and teller services at financial institutions, taking the place of human operators. Since such kiosk terminals do not need any human worker, they can be placed in various places, thereby adding convenience for users. However, since such a kiosk terminal is usually disposed at a place which is not surrounded by partitions and which is accessible by the general public, there are concerns about visual hacking from behind a user; that is, prying eyes attempting to steal on-screen confidential information such as personal information and PIN. Thus, there is a need for a technology to prevent prying eyes from reading a screen of a kiosk terminal.

Known such anti-prying eyes technologies include a kiosk terminal configured to include a front-facing monitor and an upward-facing monitor so that, when security measures are necessary, the operation screen to be used is switched to the upward-facing monitor (Patent Document 1). This configuration makes on-screen information hardly seen from behind a user to thereby improve a security

Such privacy technologies also include an automated teller machine provided with a camera capable of shooting a frontal-face video of a user who is operating the machine, the frontal-face video including a background of the user and being displayed on a monitor (display screen), where the machine is configured such that, when the user enters a password, the machine enlarges a display area for the frontal-face video shot by the camera (Patent Document 2). This configuration can provide an alert to a user for prying eyes.

### PRIOR ART DOCUMENT (S)

### Patent Document(S)

Patent Document 1: JP2010-146310A

Patent Document 2: JP4349971B

### SUMMARY OF THE INVENTION

### Task to be Accomplished by the Invention

Generally, a kiosk terminal may require complicated operations depending on the services that a user needs. In addition, when a user is unfamiliar with operations of a kiosk terminal, it is troublesome and burdensome for the user to operate the kiosk terminal while caring about whether or not there is a suspicious person prying into the screen. Therefore, what is needed is a system which enables a user to focus on operating a kiosk terminal without any concerns about prying eyes.

The above-described known anti-prying eyes technologies can help prevent prying eyes to some extent. However, the problem is that those technologies are not sufficient to virtually eliminate user's concerns about prying eyes when the user is operating a kiosk terminal.

The present invention has been made in view of such problems of the prior art, and a primary object of the present invention is to provide a bidirectional video communication system and an operator terminal used therein, which enable a user to focus on the operation of the kiosk terminal while virtually eliminating any concerns about prying eyes.

### Means to Accomplish the Task

An aspect of the present invention provides a bidirectional video communication system for bidirectional communication between a kiosk terminal and an operator terminal, the system being configured for bidirectional transmission of a video of a user who operates the kiosk terminal and a video of an operator who operates the operator terminal, wherein the kiosk terminal comprises: a communication device configured to perform communication with the operator terminal; a camera configured to shoot a frontal-face video of the user such that the frontal-face video includes a background of the user; a speaker configured to output the operator's voice received from the operator terminal; and a controller; wherein the operator terminal comprises: a communication device configured to perform communication with the kiosk terminal; a camera configured to shoot a frontal-face video of the operator; a monitor configured to display the frontal-face video of the user received from the kiosk terminal; a microphone configured to pick up a sound of the operator's voice; and a controller; and wherein the controller of the operator terminal is configured such that, upon receiving the frontal-face video of the user shot by the camera of the kiosk terminal, the controller performs face authentication on a person in the frontal-face video of the user, and that, upon detecting a suspicious person through the face authentication, the controller generates an image in which identification information distinguishably identifying the user and the suspicious person has been added to the frontal-face video of the user, and displays the image on the monitor of the operator terminal.

Another aspect of the present invention provides an operator terminal for bidirectional communication with a kiosk terminal, the operator terminal being configured for bidirectional transmission of a video of a user who operates the kiosk terminal and a video of an operator who operates the operator terminal to and from the kiosk terminal, the operator terminal comprising: a communication device configured to perform communication with the kiosk terminal; a camera configured to shoot a frontal-face video of the operator; a monitor configured to display the frontal-face video of the user received from the kiosk terminal; a microphone configured to pick up a sound of the operator's voice; and a controller, and wherein the controller is configured such that, upon receiving a frontal-face video of a user shot by a camera of the kiosk terminal such that the frontal-face video includes a background of the user, the controller displays a screen including the frontal-face video of the user on the monitor while performing face authentication on a person in the frontal-face video of the user, and that, upon detecting a suspicious person through the face authentication, the controller generates a screen in which identification information distinguishably identifying the user and the suspicious person has been added to the frontal-face video of the user, and displays the screen on the monitor.

### Effect of the Invention

The present invention enables an operator to quickly check if there is a suspicious person prying into a kiosk terminal. Upon finding such a suspicious person, the operator can verbally notify a user of the presence of the suspicious person; that is, an operator can voice words to notify a user of the presence of the suspicious person, and the voice of the operator reproduced at the kiosk terminal ensures that the user can notice the suspicious person. As a result, the user can focus on the operation of the kiosk terminal while virtually eliminating any concerns about prying eyes.

### BRIEF DESCRIPTION OF THE DRAWINGS

FIG. 1 is a diagram showing a general configuration of a bidirectional video communication system according to the present embodiment of the present invention;

FIG. 2 is a perspective view showing a kiosk terminal 1;

FIG. 3 is a perspective view showing an operator terminal 2;

FIG. 4 is a block diagram showing schematic configurations of the kiosk terminal 1 and the operator terminal 2;

FIG. 5 is an explanatory diagram showing screens displayed on the kiosk terminal 1;

FIG. 6 is an explanatory diagram showing screens displayed on the operator terminal 2;

FIG. 7 is an explanatory diagram indicating respective operation modes for prying eyes check control operations performed by the operator terminal 2;

FIG. 8 is an explanatory diagram showing screens displayed on the operator terminal 2 in a verbal notification mode;

FIG. 9 is an explanatory diagram showing a screen displayed on the operator terminal 2 in an indirect notification mode;

FIG. 10 is an explanatory diagram showing a screen displayed on the kiosk terminal 1 in an indirect notification mode;

FIG. 11 is an explanatory diagram showing a screen displayed on the kiosk terminal 1 in a direct notification mode;

FIG. 12 is an explanatory diagram showing a screen displayed on the kiosk terminal 1 in a constant display mode;

FIG. 13 is a flow chart showing an operation procedure of prying eyes check control operations;

FIG. 14 is a flow chart showing an operation procedure of prying eyes check control operations;

FIG. 15 is an explanatory diagram showing records registered in a suspicious person database managed by the operator terminal 2; and

FIG. 16 is a flow chart showing an operation procedure of face authentication control operations performed by the operator terminal 2.

### DESCRIPTION OF THE PREFERRED EMBODIMENT(S)

A first aspect of the present invention made to achieve the above-described object is a bidirectional video communication system for bidirectional communication between a kiosk terminal and an operator terminal, the system being configured for bidirectional transmission of a video of a user who operates the kiosk terminal and a video of an operator who operates the operator terminal, wherein the kiosk terminal comprises: a communication device configured to perform communication with the operator terminal; a camera configured to shoot a frontal-face video of the user such that the frontal-face video includes a background of the user; a speaker configured to output the operator's voice received from the operator terminal; and a controller;

wherein the operator terminal comprises: a communication device configured to perform communication with the kiosk terminal; a camera configured to shoot a frontal-face video of the operator; a monitor configured to display the frontal-face video of the user received from the kiosk terminal; a microphone configured to pick up a sound of the operator's voice; and a controller; and wherein the controller of the operator terminal is configured such that, upon receiving the frontal-face video of the user shot by the camera of the kiosk terminal, the controller performs face authentication on a person in the frontal-face video of the user, and that, upon detecting a suspicious person through the face authentication, the controller generates an image in which identification information distinguishably identifying the user and the suspicious person has been added to the frontal-face video of the user, and displays the image on the monitor of the operator terminal.

The present invention enables an operator to quickly check if there is a suspicious person prying into a kiosk terminal. Upon finding such a suspicious person, the operator can verbally notify a user of the presence of the suspicious person; that is, an operator can voice words to notify a user of the presence of the suspicious person, and the voice of the operator produced at the kiosk terminal ensures that the user can notice the suspicious person. As a result, the user can focus on the operation of the kiosk terminal while virtually eliminating any concerns about prying eyes.

A second aspect of the present invention is a bidirectional video communication system for bidirectional communication between a kiosk terminal and an operator terminal, the system being configured for bidirectional transmission of a video of a user who operates the kiosk terminal and a video of an operator who operates the operator terminal, wherein the kiosk terminal comprises: a communication device configured to perform communication with the operator terminal; a camera configured to shoot a frontal-face video of the user such that the frontal-face video includes a background of the user; and a controller, wherein the operator terminal comprises: a communication device configured to perform communication with the kiosk terminal; a camera configured to shoot a frontal-face video of the operator; a monitor configured to display the frontal-face video of the user received from the kiosk terminal; and a controller; wherein the controller of the operator terminal is configured such that, upon receiving the frontal-face video of the user shot by the camera of the kiosk terminal, the controller displays a screen including the frontal-face video of the user on the monitor of the operator terminal, and that, when the operator confirms that a suspicious person is present in the screen and performs an operation to instruct the controller to give an alert to the user, the controller transmits an alert notification message to the kiosk terminal; and wherein the controller of the kiosk terminal is configured such that, upon receiving the alert notification message, the controller performs a prescribed alert operation.

In this configuration, when the operator confirms that a suspicious person is present, the operator can perform a certain operation to cause the kiosk terminal to perform an alert operation, which ensures that the user can notice the suspicious person. As a result, the user, who is operating the kiosk terminal, can focus on the operation of the kiosk terminal while virtually eliminating any concerns about prying eyes.

A third aspect of the present invention is a bidirectional video communication system for bidirectional communication between a kiosk terminal and an operator terminal, the system being configured for bidirectional transmission of a video of a user who operates the kiosk terminal and a video of an operator who operates the operator terminal, wherein the kiosk terminal comprises: a communication device configured to perform communication with the operator terminal; a camera configured to shoot a frontal-face video of the user such that the frontal-face video includes a background of the user; and a controller; wherein the operator terminal comprises: a communication device configured to perform communication with the kiosk terminal; a camera configured to shoot a frontal-face video of the operator; a monitor configured to display the frontal-face video of the user received from the kiosk terminal; and a controller; wherein the controller of the operator terminal is configured such that, upon receiving the frontal-face video of the user shot by the camera of the kiosk terminal, the controller performs face authentication on a person in the frontal-face video of the user, and that, upon detecting a suspicious person through the face authentication, the controller transmits an alert notification message to the kiosk terminal; and wherein the controller of the kiosk terminal is configured such that, upon receiving the alert notification message, the controller performs a prescribed alert operation.

In this configuration, when a suspicious person appears, the kiosk terminal performs an alert operation without any involvement of an operator, which ensures that the user can notice the suspicious person. As a result, the user, who is operating the kiosk terminal, can focus on the operation of the kiosk terminal while virtually eliminating any concerns about prying eyes.

A fourth aspect of the present invention is the bidirectional video communication system of the third aspect, wherein the controller of the operator terminal is configured such that, upon detecting a suspicious person through the face authentication, the controller generates a screen in which identification information distinguishably identifying the user and the suspicious person has been added to the frontal-face video of the user, and transmits the screen to the kiosk terminal as the alert notification message; and wherein the controller of the kiosk terminal is configured to display the screen received from the operator terminal as the alert operation.

This configuration enables the user to quickly confirm the presence of a suspicious person.

A fifth aspect of the present invention is a bidirectional video communication system for bidirectional communication between a kiosk terminal and an operator terminal, the system being configured for bidirectional transmission of a video of a user who operates the kiosk terminal and a video of an operator who operates the operator terminal, wherein the kiosk terminal comprises: a communication device configured to perform communication with the operator terminal; a camera configured to shoot a frontal-face video of the user such that the frontal-face video includes a background of the user; and a controller; wherein the operator terminal comprises: a communication device configured to perform communication with the kiosk terminal; a camera configured to shoot a frontal-face video of the operator; a monitor configured to display the frontal-face video of the user received from the kiosk terminal; and a controller; wherein the controller of the operator terminal is configured such that, upon receiving the frontal-face video of the user shot by the camera of the kiosk terminal, the controller constantly transmits a screen including the frontal-face video of the user while performing face authentication on a person in the frontal-face video of the user, and that, upon detecting a suspicious person through the face authentication, the controller generates a screen in which identification information distinguishably identifying the user and the suspicious person has been added to the frontal-face video of the user, and transmits the screen to the kiosk terminal; and wherein the controller of the kiosk terminal is configured to display the screen received from the operator terminal on the monitor of the kiosk terminal.

This configuration ensures that, when a suspicious person appears, the user can notice the suspicious person. As a result, the user, who is operating a kiosk terminal, can focus on the operation of the kiosk terminal while virtually eliminating any concerns about prying eyes.

A sixth aspect of the present invention is the bidirectional video communication system of the second or third aspect, wherein the controller of the kiosk terminal is configured to display a character and/or a pictorial figure adapted to give an alert to the user as the alert operation.

This configuration enables the user to quickly confirm the presence of a suspicious person. In this case, the controller of the kiosk terminal may be configured to, in addition to displaying a visual image on the monitor, produce an alert sound.

A seventh aspect of the present invention is the bidirectional video communication system of the second or third aspect, wherein the controller of the kiosk terminal is configured to display a prescribed image in a blinking state on the monitor as the alert operation.

This configuration enables the user to quickly confirm the presence of a suspicious person.

An eighth aspect of the present invention is the bidirectional video communication system of the first, fourth, or fifth aspect, wherein the controller of the operator terminal is configured to generate, as the identification information, a screen in which a window frame image surrounding a suspicious person in the frontal-face video of the user is superimposed on the frontal-face video of the user.

This configuration enables the operator and/or the user to quickly identify a suspicious person. In this case, the identification information may include, in addition to the window frame image, pictorial figures such as arrows or icons indicating a suspicious person.

A ninth aspect of the present invention is the bidirectional video communication system of the fourth or fifth aspect, wherein the controller of the operator terminal is configured to display the frontal-face video of the user in a horizontally flipped manner.

In this configuration, the kiosk terminal displays the frontal-face video of the user in a horizontally flipped manner (as a mirrored (flipped) video). Thus, the user can determine whether a suspicious person is present on the right side or the left side of the user without error.

A tenth aspect of the present invention is the bidirectional video communication system of the first, third, or fifth aspect, wherein the controller of the operator terminal is configured such that, upon detecting a suspicious person through the face authentication, the controller registers the suspicious person on a suspicious person list.

This configuration makes it possible to check who were detected as suspicious persons afterward.

An eleventh aspect of the present invention is an operator terminal for bidirectional communication with a kiosk terminal, the operator terminal being configured for bidirectional transmission of a video of a user who operates the kiosk terminal and a video of an operator who operates the operator terminal to and from the kiosk terminal, the operator terminal comprising: a communication device configured to perform communication with the kiosk terminal; a camera configured to shoot a frontal-face video of the operator; a monitor configured to display the frontal-face video of the user received from the kiosk terminal; a microphone configured to pick up a sound of the operator's voice; and a controller, and wherein the controller is configured such that, upon receiving a frontal-face video of a user shot by a camera of the kiosk terminal such that the frontal-face video includes a background of the user, the controller displays a screen including the frontal-face video of the user on the monitor while performing face authentication on a person in the frontal-face video of the user, and that, upon detecting a suspicious person through the face authentication, the controller generates a screen in which identification information distinguishably identifying the user and the suspicious person has been added to the frontal-face video of the user, and displays the screen on the monitor.

This configuration enables the user to focus on the operation of the kiosk terminal while virtually eliminating any concerns about prying eyes in the same manner as the first aspect of the present invention.

A twelfth aspect of the present invention is an operator terminal for bidirectional communication with a kiosk terminal, the operator terminal being configured for bidirectional transmission of a video of a user who operates the kiosk terminal and a video of an operator who operates the operator terminal to and from the kiosk terminal, the operator terminal comprising: a communication device configured to perform communication with the kiosk terminal; a camera configured to shoot a frontal-face video of the operator; a monitor configured to display the frontal-face video of the user received from the kiosk terminal; and a controller, and wherein the controller is configured such that, upon receiving a frontal-face video of a user shot by a camera of the kiosk terminal such that the frontal-face video includes a background of the user, the controller displays a screen including the frontal-face video of the user on the monitor, and that, when the operator confirms that a suspicious person is present in the screen and performs an operation to instruct the controller to give an alert to the user, the controller transmits an alert notification message to the kiosk terminal, thereby causing the kiosk terminal to perform a prescribed alert operation.

This configuration enables the user to focus on the operation of the kiosk terminal while virtually eliminating any concerns about prying eyes in the same manner as the second aspect of the present invention.

A thirteenth aspect of the present invention is an operator terminal for bidirectional communication with a kiosk terminal, the operator terminal being configured for bidirectional transmission of a video of a user who operates the kiosk terminal and a video of an operator who operates the operator terminal to and from the kiosk terminal, the operator terminal comprising: a communication device configured to perform communication with the kiosk terminal; a camera configured to shoot a frontal-face video of the operator; a monitor configured to display the frontal-face video of the user received from the kiosk terminal; and a controller, and wherein the controller is configured such that, upon receiving a frontal-face video of a user shot by a camera of the kiosk terminal such that the frontal-face video includes a background of the user, the controller performs face authentication on a person in the frontal-face video of the user, and that, upon detecting a suspicious person through the face authentication, the controller transmits an alert notification message to the kiosk terminal, thereby causing the kiosk terminal to perform a prescribed alert operation.

This configuration enables the user to focus on the operation of the kiosk terminal while virtually eliminating any concerns about prying eyes in the same manner as the third aspect of the present invention.

A fourteenth aspect of the present invention is an operator terminal for bidirectional communication with a kiosk terminal, the operator terminal being configured for bidirectional transmission of a video of a user who operates the kiosk terminal and a video of an operator who operates the operator terminal to and from the kiosk terminal, the operator terminal comprising: a communication device configured to perform communication with the kiosk terminal; a camera configured to shoot a frontal-face video of the operator; a monitor configured to display the frontal-face video of the user received from the kiosk terminal; and a controller, and wherein the controller is configured such that, upon receiving a frontal-face video of a user shot by a camera of the kiosk terminal such that the frontal-face video includes a background of the user, the controller constantly transmits a screen including the frontal-face video of the user to cause the kiosk terminal to display the screen on a monitor of the kiosk terminal while performing face authentication on a person in the frontal-face video of the user, and that, upon detecting a suspicious person through the face authentication, the controller generates a screen in which identification information distinguishably identifying the user and the suspicious person has been added to the frontal-face video of the user, and causes the kiosk terminal to display the screen on the monitor of the kiosk terminal.

This configuration enables the user to focus on the operation of the kiosk terminal while virtually eliminating any concerns about prying eyes in the same manner as the fifth aspect of the present invention.

Embodiments of the present invention will be described below with reference to the drawings.

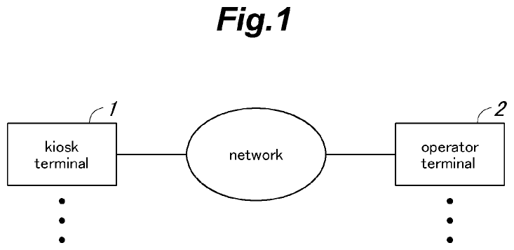

FIG. 1 is a diagram showing a general configuration of a bidirectional video communication system according to the present embodiment.

The bidirectional video communication system includes a kiosk terminal 1 and an operator terminal 2. The kiosk terminal 1 and the operator terminal 2 are connected to each other via a network such as the Internet, a VPN (Virtual Private Network) or an intranet.

The kiosk terminal 1 is disposed in various facilities and adapted to be operated by a user. The kiosk terminal 1 is configured to transmit a video of the user to the operator terminal 2 and to display a video of an operator received from the operator terminal 2.

The operator terminal 2 is disposed in a facility such as a call center where operators who respond to users are present at all times, and is adapted to be operated by an operator. The operator terminal 2 is configured to transmit a video of an operator to the kiosk terminal 1 and display a video of a user received from the kiosk terminal 1.

The kiosk terminal 1 can provide various services. For example, the kiosk terminal 1 can be disposed in a lobby of a transportation facility such as an airport to thereby provide services such as providing information on nearby sightseeing spots, information on floors in the facility, and information on nearby accommodation facilities. The kiosk terminal 1 can be disposed in a branch of a financial institution such as a bank to thereby provide various services provided at a counter in the branch, such as consulting services associated with opening an account, financial transactions and customer loan. The kiosk terminal 1 is disposed at a reception counter of an accommodation facility such as a hotel to thereby provide various receptionist's services provided by a staff member (concierge). Moreover, the kiosk terminal 1 can be disposed in the entrance lobby of an apartment such as a condominium to thereby provide various services provided by a building janitor.

In this manner, the kiosk terminal 1 can constantly provide various services in place of a person in charge, and thus it becomes possible to improve the quality of services. In addition, since an operator can take charge of a plurality of facilities, it becomes possible to downsize employees.

The kiosk terminal 1 and the operator terminal 2 perform bidirectional communication with each other, transmitting a video of a user and that of an operator to each other. In addition, the kiosk terminal 1 and the operator terminal 2 perform bidirectional communication with each other, transmitting to each other operation information which the user and the operator enter on the kiosk terminal 1 and the operator terminal 2, respectively.

In particular, the terminals can transmit confidential information (for example, personal information such as user's name and address, or a financial institution account number) to each other. For transmission of such confidential information, since a service provider already provides a highly secure network, the terminals may be configured to transmit confidential information other than video via the existing highly secure network while transmitting video via a different network. In this configuration, a necessary security for transmission of confidential information is ensured by using the existing network, whereas video contents, which require a large amount of communication in transmission, can be transmitted over a different network, thereby preventing an increase in the load on the existing network.

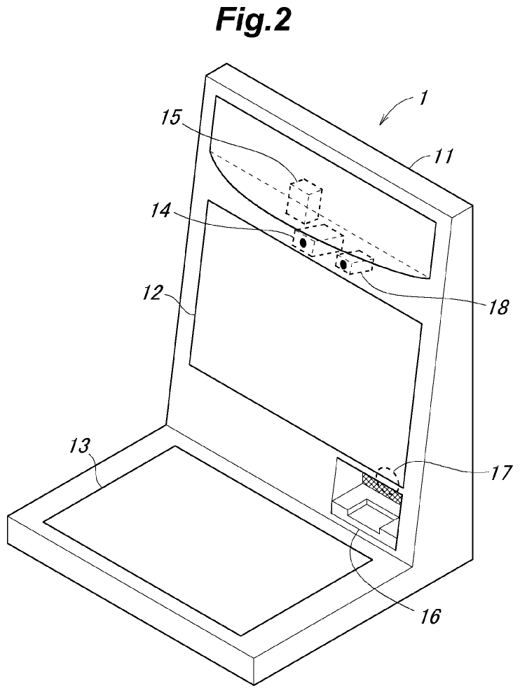

Next, the kiosk terminal 1 will be described. FIG. 2 is a perspective view showing the kiosk terminal 1.

The kiosk terminal 1 includes a housing 11, a front-facing monitor 12, an upward-facing monitor 13, a front-facing camera 14, a downward-facing camera 15, an IC card reader 16, a speaker 17, and a microphone 18.

The front-facing monitor 12 is arranged with its screen facing forward, and the upward-facing monitor 13 is arranged with its screen facing upward. In addition, the upward-facing monitor 13 includes a touchscreen so that users can operate the touchscreen to invoke actions.

The front-facing camera 14 is used to shoot a video of a user's upper body including the user's face from front. The downward-facing camera 15 is used to shoot a video of where the user's hands are placed; that is, shoot a video of the user's hand placed on the upward-facing monitor 13 from above. The user points a finger on the screen of the upward-facing monitor 13, and this situation is shot by the downward-facing camera 15.

The IC card reader 16 reads an IC card carried by the user.

The speaker 17 outputs voice of the operator. The microphone 18 picks up a sound of the user's voice.

The kiosk terminal 1, which is configured this way, is placed on a base such as a counter so that a user can operate the kiosk terminal 1 while sitting on the chair or standing. Since the kiosk terminal 1 is disposed at a place which is not surrounded by partitions, any person other than the user who is operating the kiosk terminal can pry into the screen of the kiosk terminal 1 from behind the user.

Thus, in the present embodiment, the front-facing camera 14 is configured to shoot a frontal-face video of the user such that the frontal-face video includes a background of the user; that is, the displayed frontal-face video includes a person prying into the screen behind the user so that the frontal-face video shot by the front-facing camera 14 can be used to notify the user that there is a suspicious person who is prying into the screen.

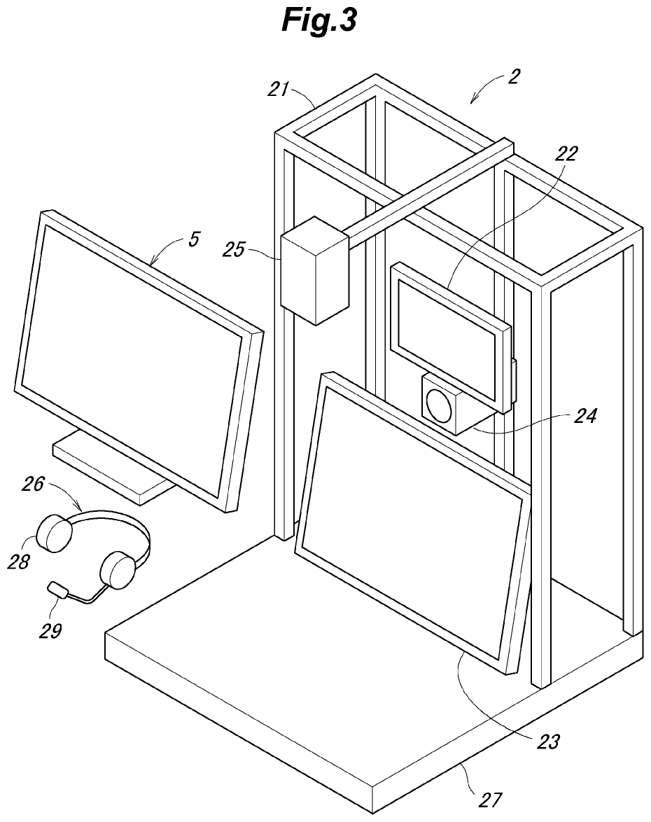

Next, the operator terminal 2 will be described. FIG. 3 is a perspective view showing the operator terminal 2.

The operator terminal 2 includes a frame 21, a first monitor 22, a second monitor 23, a front-facing camera 24, a downward-facing camera 25, a headset 26, and a table 27.

The first monitor 22 is supported by the frame 21 so as to be located at a predetermined height. The second monitor 23 includes a touchscreen so that an operator can operate the touchscreen to invoke actions.

The front-facing camera 24 is used to shoot an operator's upper body including the face from front. The downward-facing camera 25 is used to shoot a video of where the operator's hands can be placed; that is, shoot a video of the operator's hand placed on the table 27 from above. The operator, putting a document such as a brochure on the table, explains the document while pointing a finger on the document, and this situation is shot by the downward-facing camera 25.

The headset 26 includes a speaker 28 and a microphone 29. The speaker 28 outputs voice of the user. The microphone 29 picks up a sound of the operator's voice.

The operator terminal 2 is also provided with a monitor 5. The monitor 5 displays a screen of an application running on the operator terminal 2 or a PC (not shown). The operator terminal 2 shares the screen of the application with the kiosk terminal 1 so that the same screen is displayed on the upward-facing monitor 13 of the kiosk terminal 1 (screen sharing function). The monitor 5 includes a touchscreen, and an operator can draw on the screen by handwriting (whiteboard function).

In a call center, each of the operators uses the operator terminal 2 not only to provide face-to-face services to a user through video and voice, but also to provide telephone reception services by responding to a user only by voice over the telephone. Thus, the operator terminal 2 is also equipped with a monitor (not shown) for telephone reception services.

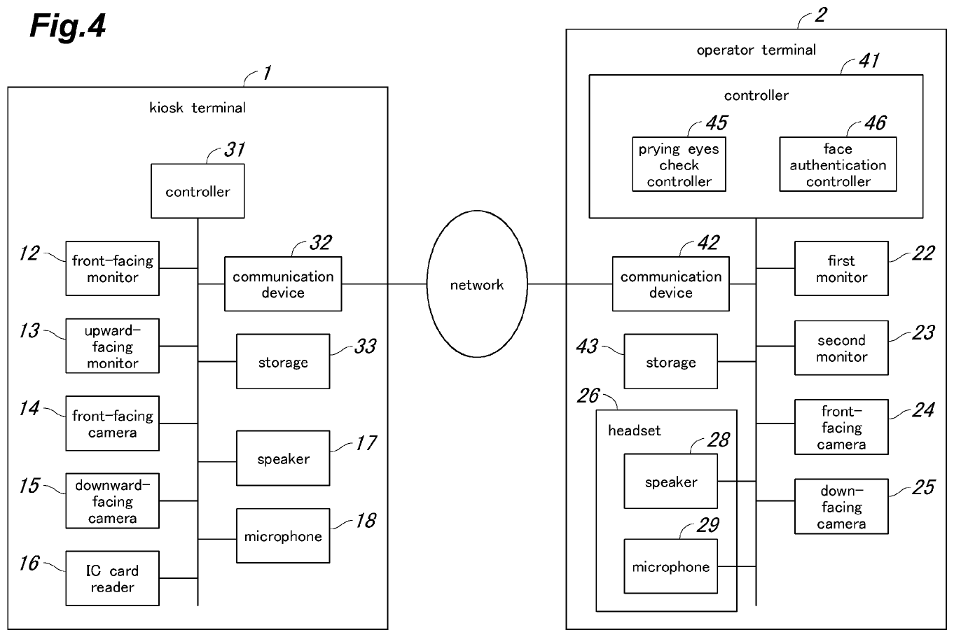

Next, schematic configurations of the kiosk terminal 1 and the operator terminal 2 will be described. FIG. 4 is a block diagram showing schematic configurations of the kiosk terminal 1 and the operator terminal 2.

As described above, the kiosk terminal 1 includes the front-facing monitor 12, the upward-facing monitor 13, the front-facing camera 14, the downward-facing camera 15, the IC card reader 16, the speaker 17, and the microphone 18. The kiosk terminal 1 also includes a controller 31, a communication device 32, and a storage 33.

The communication device 32 performs communication with the operator terminal 2 via a network.

The storage 33 stores programs executable by a processor, which implements the controller 31. The storage 33 also stores video data of contents displayed on the front-facing monitor 12 when the front-facing monitor 12 operates as digital signage during standby.

The controller 31 is configured by the processor, which executes a program stored in the storage 33 to thereby execute a predetermined process. In the present embodiment, the controller 31 performs connection control operations to make a connection to the operator terminal 2, and also performs video transmission control for real-time transmission/reception of videos of the user and the operator shot by the kiosk terminal 1 and the operator terminal 2, respectively.

As described above, the operator terminal 2 includes the first monitor 22, the second monitor 23, the front-facing camera 24, the downward-facing camera 25, and the headset 26. The operator terminal 2 also includes a controller 41, a communication device 42, and a storage 43.

The communication device 42 performs communication with the kiosk terminal 1 via the network.

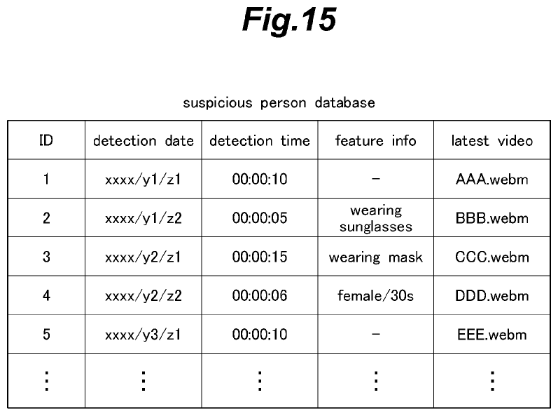

The storage 43 stores programs executable by a processor, which implements the controller 41. The storage 43 also stores records registered in a suspicious person database, the records being associated with suspicious persons detected through face authentication (see FIG. 15).

The controller 41 includes a prying eyes check controller 45 and a face authentication controller 46. The controller 41 is configured by a processor, and each unit of the controller 41 is implemented by executing a program stored in the storage 43 by the processor.

The prying eyes check controller 45 performs controls to urge an operator and a user to check for a suspicious person prying into the screen depending on the operation mode (verbal notification mode, indirect notification mode, direct notification mode, and constant display mode). In particular, when the face authentication controller 46 detects a suspicious person, the prying eyes check controller 45 causes the operator terminal 2 to perform an alert notification operation notifying the operator of the detection, and transmits an alert notification message to the kiosk terminal 1 causing the kiosk terminal 1 to perform an alert operation for the user. In addition, in the present embodiment, as the notification operation to the operator, the prying eyes check controller 45 displays on the operator terminal 2 a screen in which a suspicious person is highlighted in the frontal-face video of the user. Also, as the alert operation for the user, the prying eyes check controller 45 causes the kiosk terminal 1 to display on the kiosk terminal 1 a screen in which a suspicious person is highlighted in the frontal-face video of the user, and also display an alert message on the kiosk terminal 1.

The face authentication controller 46 performs face authentication on the frontal-face video of the user received from the kiosk terminal 1 to detect, as a suspicious person, a person who is not one operating the kiosk terminal 1 and not his or her companion. Specifically, the face authentication controller 46 detects the face of a person in the frontal-face video of the user, and considers the face(s) appearing from the beginning of the video as a person operating the kiosk terminal 1 and his or her companion, registers the person as a user(s), and when a different person from the user(s) appears during the user's operation, the face authentication controller 46 detects the different person as a suspicious person.

Furthermore, the controller 41 performs connection control to make a connection to the kiosk terminal 1, and also performs video transmission control for real-time transmission/reception of videos of the user and the operator which are shot by the kiosk terminal 1 and the operator terminal 2, respectively.

It should be noted that the operator terminal 2 may be provided with a scanner used for scanning a document(s) an operator has. In addition, the operator terminal 2 may be provided with an IC card reader used to authenticate an operator who operates the terminal as an authorized operator. Moreover, the kiosk terminal 1 may be provided with a printer used to print out a document transmitted from the operator terminal 2 or information displayed on the screen.

The second monitor 23 may be configured by a tablet PC; that is, configured such that the controller 41, the communication device 42, and the storage 43 are accommodated in a housing of the second monitor 23.

Although, in the present embodiment, in the direct notification mode and the constant display mode, the operator terminal 2 detects a suspicious person through face authentication and cause the kiosk terminal 1 to perform the alert operation, the kiosk terminal 1 may be configured to detect a suspicious person through face authentication and performs the alert operation.

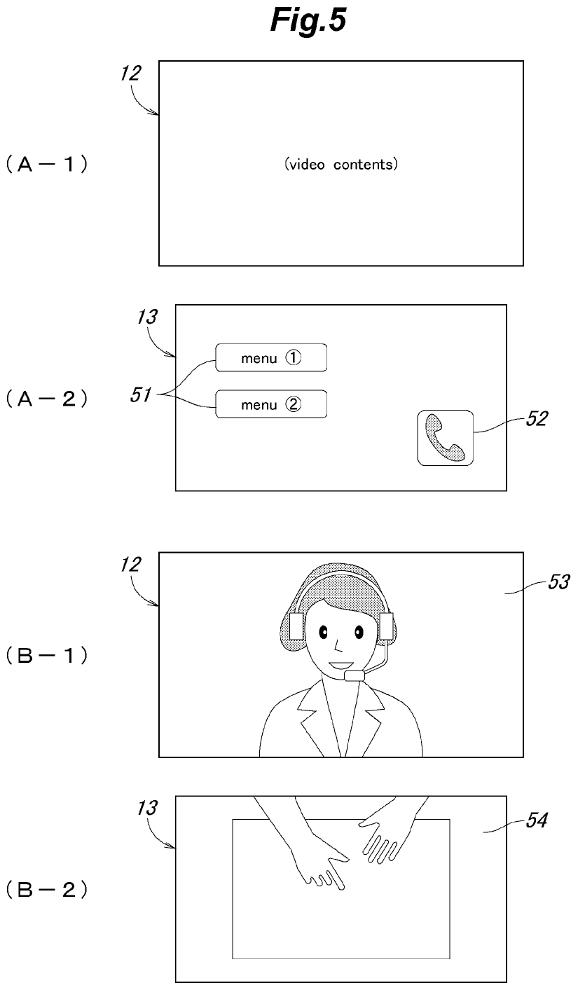

Next, screens displayed on the kiosk terminal 1 will be described. FIG. 5 is an explanatory diagram showing the screens displayed on the kiosk terminal 1.

In the kiosk terminal 1, the front-facing monitor 12 operates as digital signage during standby (before connecting to the operator terminal 2), and as shown in FIG. 5(A-1), the kiosk terminal 1 displays on the front-facing monitor 12 video contents relating to advertisements such as recommended plans and guide maps of facilities.

Also, during standby, as shown in FIG. 5(A-2), a menu screen (operation screen) is displayed on the upward-facing monitor 13. The menu screen includes displayed operation buttons 51 corresponding to various menu items. The menu screen also includes a call button 52. When the user operates the call button 52, the kiosk terminal 1 makes a connection to the operator terminal 2 so that the kiosk terminal 1 can start interaction with the operator. The controller 31 may be configured such that, when a sensor such as a human sensor detects the user in front of the kiosk terminal 1, the controller 31 automatically launches the menu screen, and when the kiosk terminal 1 is continuously in a non-use state for a predetermined period of time, the controller 31 shifts the screen from the menu screen to a screen in non-displayed state.

When the front-facing monitor 12 operates as digital signage, the kiosk terminal 1 may read data of video contents pre-stored in the storage 33 in order to reproduce the video contents. In this case, the kiosk terminal 1 may be configured such that a memory card storing video contents data is be attached to the kiosk terminal 1, or the video contents data is distributed from a distribution server to the kiosk terminal 1 via the network.

When the kiosk terminal 1 is connected to the operator terminal 2, the front-facing monitor 12 displays a frontal-face video 53 of the operator shot by the front-facing camera 24 of the operator terminal 2 as shown in FIG. 5(B-1), and simultaneously, the upward-facing monitor 13 displays a video 54 of the operator's hand shot by downward-facing camera 25 of the operator terminal 2 as shown in FIG. 5(B-2).

The front-facing monitor 12 displays the frontal-face video 53 of the operator so that the height of the eyes of the user matches that of the operator, whereas the upward-facing monitor 13 displays a video 54 of the operator's hands so that the height of the user matches that of the operator. As a result, the user can experience a realistic sensation that the user faces the operator over the counter.

The video 54 of the operator's hands displayed on the upward-facing monitor 13 shows a situation in which the operator makes an explanation, pointing a finger on a document such as a brochure, so that the user and the operator can interact with each other while pointing their fingers on the document.

The operator can perform an operation on the operator terminal so that the upward-facing monitor 13 of the kiosk terminal 1 displays a screen of an application. The kiosk terminal 1 shares the screen of the application with the operator terminal 2 so that the same screen is displayed on the operator terminal 2 (screen sharing function). Also, the user can draw on the screen of the application by handwriting (whiteboard function).

The kiosk terminal 1 may be configured such that the front-facing monitor 12 displays a frontal-face video of the operator with the operator's background masked.

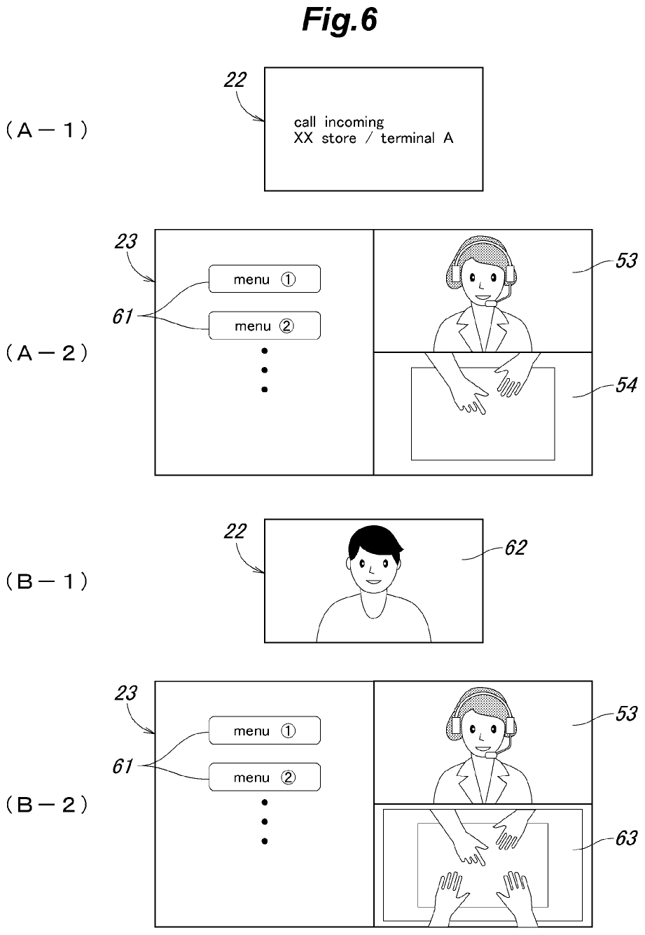

Next, screens displayed on the operator terminal 2 will be described. FIG. 6 is an explanatory diagram showing the screens displayed on the operator terminal 2.

During standby, the first monitor 22 of the operator terminal 2 displays a standby screen, and when the user operates the call button 52 (see FIG. 5(A-2)), a call incoming screen as shown in FIG. 6(A-1) is displayed on the first monitor 22. The call incoming screen shows information on the counterpart kiosk terminal 1 (such as disposed location or terminal name).

During standby, an operation screen as shown in FIG. 6(A-2) is displayed on the second monitor 23 of the operator terminal 2. The operation screen shows operation buttons 61 corresponding to various menu items such as those used to control the operator terminal 2 and give instructions to the kiosk terminal 1.

The second monitor 23 displays the frontal-face video 53 of the operator shot by the front-facing camera 24 of the operator terminal 2 and the video 54 of the operator's hands shot by downward-facing camera 25 of the operator terminal 2, which are both same as those displayed on the kiosk terminal 1. The video 54 of the operator's hands can be switched between the video displayed in the original form and that in a vertically flipped form.

When the operator terminal 2 is connected to the kiosk terminal 1, the first monitor 22 displays a frontal-face video 62 of the user shot by the front-facing camera 14 of the kiosk terminal 1 as shown in FIG. 6(B-1). The first monitor 22 is supported by the frame 21 so as to be located at a predetermined height (see FIG. 3), which allows the height of the operator' eyes to match that of the user's eyes.

As shown in FIG. 6B-2, the second monitor 23 displays the operation buttons 61 in the same manner as during standby. The second monitor 23 also displays the frontal-face video 53 of the operator in the same manner as during standby. The screen displayed on the second monitor can be switched between the frontal-face video 53 of the operator and the video of the operator's hands. The second monitor 23 displays a video 63 of the user's hands shot by the downward-facing camera 15 of the kiosk terminal 1 concurrently with displaying the video of the operator's hands. The video 63 of the user's hands can be switched between the video displayed in the original form and that in a vertically flipped form.

The video 63 of the user's hands displayed on the second monitor 23 shows a situation in which the user points a finger on a document such as a brochure on the upward-facing monitor 13 of the kiosk terminal 1, so that the user and the operator can interact with each other while pointing their fingers on the document.

In the present embodiment, the operator terminal 2 is configured such that the first monitor 22 displays the frontal-face video 62 of the user, and the second monitor 23 displays the video 63 of the user's hands. However, the operator terminal 2 may be configured such that a single monitor displays the user's frontal-face video 62 and the video 63 of the user's hands. In this case, the operator can experience a realistic sensation that the operator faces the user over the counter.

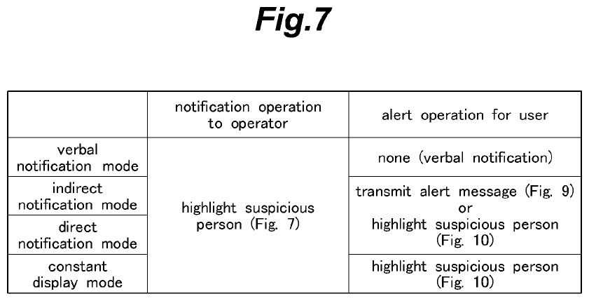

Next, prying eyes check control operations performed by the operator terminal 2 will be described. FIG. 7 is an explanatory diagram indicating respective operation modes for the prying eyes check control operations.

The prying eyes check controller 45 of the operator terminal 2 performs control such that the prying eyes check controller 45 determines in which of the preset operation modes the operator terminal 2 operates, and, based on the result of the determination, the prying eyes check controller 45 causes the operator terminal 2 to perform a notification operation for the operator, and causes the kiosk terminal 1 to perform an alert operation for the user. In the present embodiment, there are four operation modes: a verbal notification mode, an indirect notification mode, a direct notification mode, and a constant display mode. These operation modes can be selected by an administrator or an operator.

In the verbal notification mode, when the operator terminal 2 detects a suspicious person in the frontal-face video of the user through face authentication, the operator terminal 2 displays a screen in which the suspicious person is highlighted in the frontal-face video of the user to thereby notify the operator of the presence of the suspicious person. When confirming the presence of the suspicious person, the operator can verbally notify the user of the presence of the suspicious person to urge the user to be careful about the suspicious person. In other embodiments, the operator terminal 2 may be configured such that the operator determines if there is a suspicious person through visual check without performing face authentication.

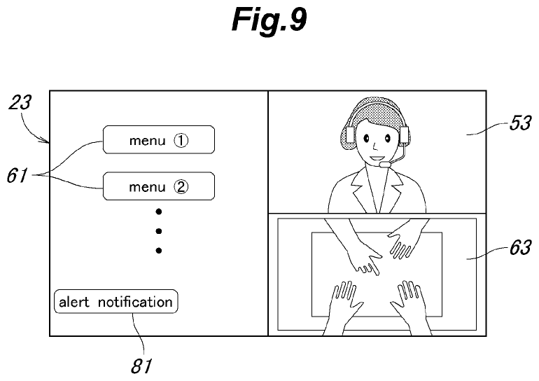

In the indirect notification mode, in a similar manner to the verbal notification mode, when the operator terminal 2 detects a suspicious person in the frontal-face video of the user through face authentication, the operator terminal 2 displays a screen in which the suspicious person is highlighted in the frontal-face video of the user to thereby notify the operator of the presence of the suspicious person. If the operator confirms the presence of the suspicious person and performs an operation to instruct the operator terminal to give an alert to the user (touch an alert notification button 81 shown in FIG. 9), the operator terminal causes the kiosk terminal 1 to display an alert message as an alert operation for the user. The operator terminal 2 may be configured such that the operator terminal 2 causes the kiosk terminal to display a screen in which the suspicious person is highlighted in the frontal-face video of the user. In other embodiments, the operator terminal 2 may be configured such that the operator determine if there is a suspicious person through visual check without performing face authentication.

In the direct notification mode, when the operator terminal 2 detects a suspicious person in the frontal-face video of the user through face authentication, the operator terminal 2 causes the kiosk terminal 1 to display a screen in which the suspicious person is highlighted in the frontal-face video of the user as an alert operation for the user, without any involvement of the operator. The operator terminal 2 may be configured such that the operator terminal 2 causes the kiosk terminal to display an alert message.

In the constant display mode, the operator terminal 2 causes the kiosk terminal to constantly display the frontal-face video of the user on the kiosk terminal 1, and when the operator terminal 2 detects a suspicious person in the frontal-face video of the user through face authentication, the operator terminal 2 causes the kiosk terminal 1 to display a screen in which the suspicious person is highlighted in the frontal-face video of the user.

The operator terminal 2 may be configured such that, when the kiosk terminal 1 displays the suspicious person highlighted in the frontal-face video of the user, the operator terminal 2 also causes kiosk terminal 1 to perform another alert operation such as producing an alert sound.

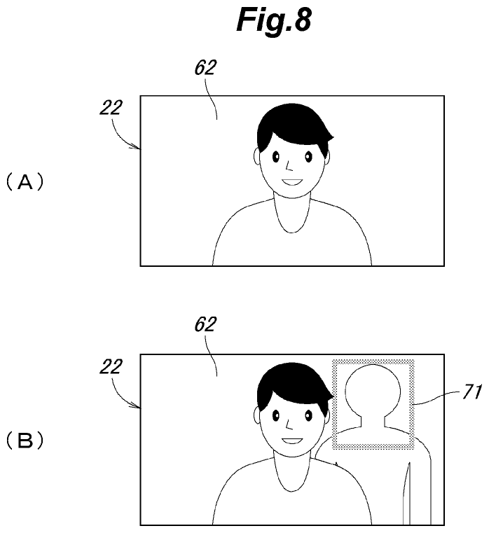

Next, the verbal notification mode will be described. FIG. 8 is an explanatory diagram showing screens displayed on the operator terminal 2.

In the operator terminal 2, as shown in FIG. 8A, the first monitor 22 displays the frontal-face video 62 of the user shot by the front-facing camera 14 of the kiosk terminal 1.

The operator terminal 2 performs a processing operation to detect a suspicious person in the frontal-face video 62 of the user through face authentication, and if the suspicious person is detected, the operator terminal 2 highlights the suspicious person in the frontal-face video of the user displayed on the first monitor 22 to thereby notify the operator of the presence of the suspicious person. Specifically, as shown in FIG. 8B, the suspicious person is displayed with a window frame image 71 surrounding the suspicious person which is superimposed on the frontal-face video of the user. Preferably, the window frame image 71 is displayed in a color with high visibility (for example, red) or in a blinking state. The shape of the window frame image 71 is not limited to a rectangle and may be another shape such as a circle. In other embodiments, instead of the window frame image 71, characters such as “Suspicious person detected!” may be superimposed on the frontal-face video of the user.

The operator sees the frontal-face video 62 of the user and determines if there is a suspicious person through visual check. When confirming the presence of such a suspicious person, the operator verbally notifies the user that the suspicious person is present behind the user. That is, the microphone 29 picks up the voice produced by the operator, and then the speaker 17 of the kiosk terminal 1 reproduces the voice. As a result the operator can urge the user to be careful about the suspicious person.

Although, in the present embodiment, the operator terminal 2 is configured to detect a suspicious person through face authentication, the operator terminal 2 may be configured such that, without performing face authentication, the operator finds a suspicious person in the frontal-face video of the user through visual check.

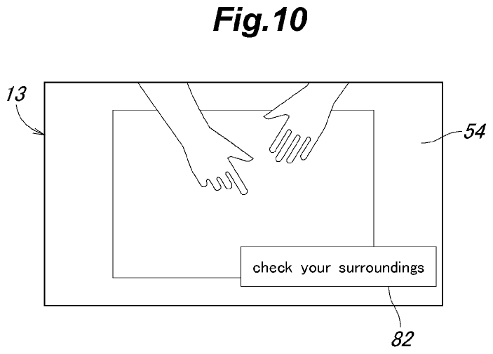

Next, the indirect notification mode will be described. FIG. 9 is an explanatory diagram showing a screen displayed on the operator terminal 2 in the indirect notification mode. FIG. 10 is an explanatory diagram showing a screen displayed on the kiosk terminal 1 in the indirect notification mode.

In the indirect notification mode, when detecting a suspicious person in the frontal-face video of the user through face authentication, the operator terminal 2 causes the kiosk terminal 1 to perform an alert operation in response to the operator's operation. Specifically, as shown in FIG. 9, the second monitor 23 of the operator terminal 2 displays an alert notification button 81, and when the operator operates the alert notification button 81, as shown in FIG. 10, the upward-facing monitor 13 of the kiosk terminal 1 displays an alert (text) message such as characters “Check your surroundings.”

In the indirect notification mode, in the same manner as the verbal notification mode (see FIG. 8), the first monitor 22 of the operator terminal 2 displays the frontal-face video 62 of the user, and when detecting a suspicious person in the frontal-face video 62 of the user through face authentication, the operator terminal 2 displays the suspicious person with a window frame image 71 surrounding the suspicious person. The operator sees the frontal-face video 62 of the user displayed on the first monitor 22 and determines if the detected person is actually a suspicious person through visual check. Upon confirming the presence of such a suspicious person, the operator operates the alert notification button 81.

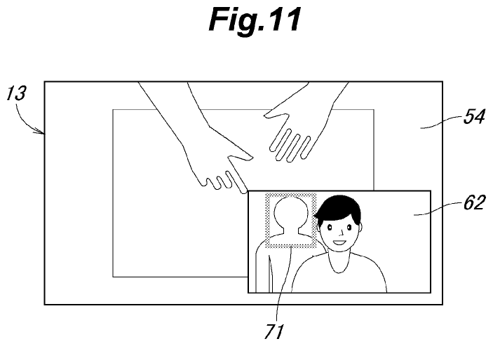

Next, the direct notification mode will be described. FIG. 11 is an explanatory diagram showing a screen displayed on the kiosk terminal 1 in the direct notification mode.

In the direct notification mode, when detecting a suspicious person in the frontal-face video of the user through face authentication, the operator terminal causes the kiosk terminal to notify the user of the presence of the suspicious person who is prying into the screen without any involvement of the operator. In the present embodiment, the frontal-face video 62 of the user is displayed with a wipe effect (i.e. superimposed) on the video 54 of operator's hands displayed on the monitor 13 of the kiosk terminal 1.

The frontal-face video 62 of the user is displayed in a horizontally flipped manner (as a mirrored (flipped) video). As a result, the user can determine whether the suspicious person is present on the right side or left side of the user without error.

In addition, the operator terminal 2 causes the kiosk terminal 1 to display a screen in which a suspicious person is highlighted in the frontal-face video 62 of the user. Specifically, the suspicious person is displayed with a window frame image 71 surrounding the suspicious person in the frontal-face video 62 of the user. This configuration enables a user to quickly notice the presence of a suspicious person behind the user. Preferably, the window frame image 71 is displayed in a color with high visibility (for example, red) or in a blinking state.

In the present embodiment, the operator terminal 2 is configured to cause the kiosk terminal 1 to display the frontal-face video 62 of the user including a suspicious person with a wipe effect. However, in the same manner as the example shown in FIG. 10, the operator terminal 2 may be configured to cause the kiosk terminal 1 to display an alert (text) message. In addition, in the indirect notification mode, the operator terminal 2 may cause the kiosk terminal 1 to display a frontal-face video of the user including a suspicious person with a wipe effect in the same manner as the example shown in FIG. 11.

In the present embodiment, the operator terminal is configured such that the kiosk terminal 1 displays on the upward-facing monitor 13 the frontal-face video of the user including a suspicious person with a wipe effect. However, the operator terminal may be configured such that the kiosk terminal 1 displays the frontal-face video of the user on the front-facing monitor 12.

In the present embodiment, the operator terminal 2 is configured such that, in the indirect notification mode and the direct notification mode, a screen display of the kiosk terminal is used to notify the user of the presence of a suspicious person. However, the operator terminal 2 may be configured such that, in addition to the screen display or instead of the screen display, a sound such as an alert sound is used to notify the user of the presence of a suspicious person.

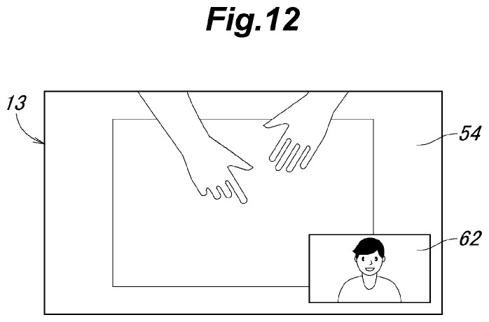

Next, the constant display mode will be described. FIG. 12 is an explanatory diagram showing a screen displayed on the kiosk terminal 1 in the constant display mode.

In the constant display mode, the operator terminal 2 causes the kiosk terminal 1 to display frontal-face video 62 of the user such that the frontal-face video 62 of the user is constantly displayed with a wipe effect (i.e. superimposed) on the video 54 of the operator's hands displayed on the upward-facing monitor 13. The frontal-face video 62 of the user is displayed in a horizontally flipped manner (as a mirrored (flipped) video).

Furthermore, in the constant display mode, when detecting a suspicious person in the frontal-face video 62 of the user through face authentication, the operator terminal 2 causes the kiosk terminal 1 to display a screen in which a suspicious person is highlighted in the frontal-face video 62 of the user. Specifically, in the same manner as the example shown in FIG. 11, the suspicious person is displayed with a window frame image 71 surrounding the suspicious person in the frontal-face video 62 of the user.

In the constant display mode, since the frontal-face video 62 of the user is displayed in a horizontally flipped manner, the frontal-face video of the user serves as an anti-prying eyes mirror showing a background of the user. In addition, when a suspicious person is detected in the frontal-face video of the user, the suspicious person is highlighted in the frontal-face video 62 of the user, which enables the user to quickly notice the presence of the suspicious person.

The operator terminal 2 displays, on the second monitor 23, the frontal-face video of the user in a non-flipped manner. As a result, when the user does not notice a suspicious person, the operator can verbally urge the user to be careful about the suspicious person.

In the present embodiment, the operator terminal 2 is configured such that, when operating in the indirect notification mode, the direct notification mode, and the constant display mode, the operator terminal 2 causes the kiosk terminal 1 to display a frontal-face video of the user with a wipe effect or display an alert (text) message. In other embodiments, the operator terminal 2 may be configured to cause the kiosk terminal 1 to display alert pictorial figures such as icons.

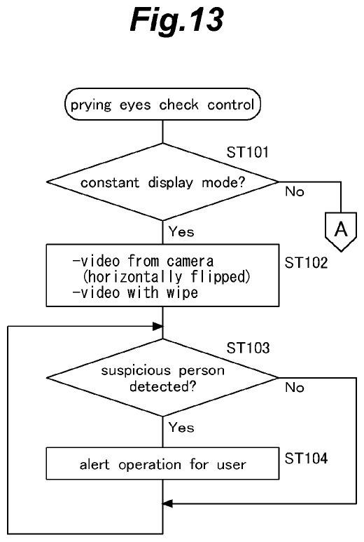

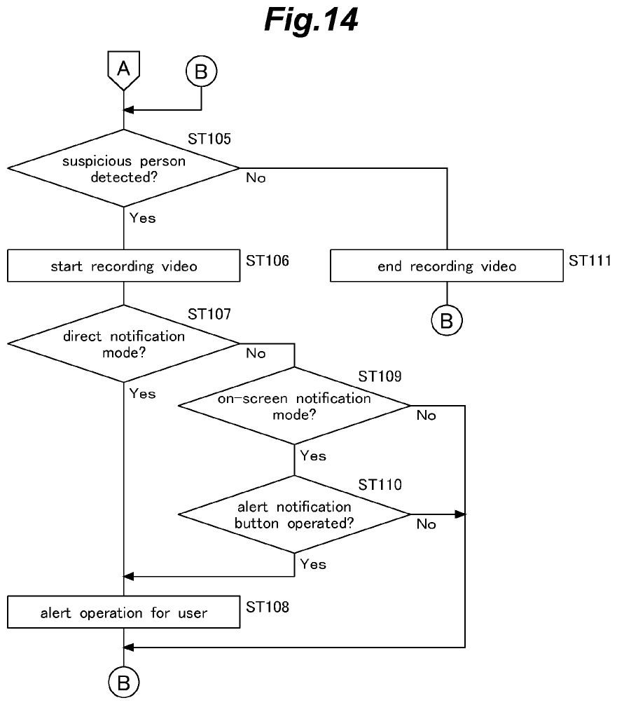

Next, prying eyes check control operations will be described. FIGS. 13 and 14 are flow charts showing an operation procedure of prying eyes check control operations.

First, an operator terminal 2 determines whether or not the operator terminal is operating in the constant display mode (ST101). When operating in the constant display mode (Yes in ST101), the operator terminal 2 generates a screen in which a frontal-face video 62 of a user received from a kiosk terminal 1 is displayed with a wipe effect on a video 54 of the operator's hands shot by the downward-facing camera 25, and then transmits the screen to the kiosk terminal 1, thereby causing the kiosk terminal 1 to display the screen on the upward-facing monitor 13 (ST102, see FIG. 12). The frontal-face video of the user is displayed in a horizontally flipped manner.

Next, when detecting a suspicious person through face authentication (Yes in ST103), the operator terminal 2 causes the kiosk terminal 1 to perform an alert operation for the user (ST104). Specifically, the operator terminal 2 causes the kiosk terminal 1 to display a window frame image 71 surrounding the suspicious person on the frontal-face video 62 of the user displayed on the upward-facing monitor 13 with a wipe effect (see FIG. 11). If the operator terminal 2 does not detect any suspicious person (No in ST103), the operator terminal 2 does not cause the kiosk terminal 1 to perform an alert operation for the user.

When the operator terminal 2 does not operate in the constant display mode (No in ST101) and detects a suspicious person through face authentication (Yes in ST105), the operator terminal 2 starts recording a video (ST106). Then, the operator terminal 2 determines whether or not the operator terminal is operating in the direct notification mode (ST107).

When operating in the direct notification mode (Yes in ST107), the operator terminal 2 causes the kiosk terminal 1 to perform an alert operation for the user (ST108). Specifically, the operator terminal 2 generates a screen in which the frontal-face video 62 of the user received from the kiosk terminal 1 is displayed with a wipe effect on video 54 of the operator's hand shot by the downward-facing camera 25, and then transmits the screen to the kiosk terminal 1, causing the kiosk terminal 1 to display the screen on the upward-facing monitor 13 (see FIG. 11). In this step, the upward-facing monitor 13 displays the frontal-face video 62 of the user in a horizontally flipped manner, and a window frame image 71 surrounding the suspicious person on the frontal-face video 62 of the user. Then, the process returns to ST105.

If the operator terminal 2 does not operate in the direct notification mode (No in ST107), then the operator terminal 2 determines whether or not the operator terminal is operating in the indirect notification mode (ST109).

When operating in the indirect notification mode (Yes in ST109), the operator terminal 2 determines whether or not the operator operates the alert notification button 81 (see FIG. 9) (ST110). If the operator operates the alert notification button 81 (Yes in ST110), the process proceeds to ST108, in which the operator terminal 2 causes the kiosk terminal 1 to perform an alert operation for the user. For example, the operator terminal 2 causes the kiosk terminal 1 to display an alert message (e.g. characters “check your surroundings”) (see FIG. 10).

When the operator terminal 2 does not operate in the indirect notification mode; that is, the operator terminal 2 operates in the verbal notification mode (No in ST109) or the operator does not operate the alert notification button 81 (No in ST110), the operator terminal 2 does not perform any processing operation, and the process returns to ST105.

If the operator terminal 2 does not detect any suspicious person through face authentication (No in ST105) and is recording a video, the operator terminal 2 ends recording the video (ST111). In this step, if the kiosk terminal is performing an alert operation for the user, the operator terminal 2 stops the alert operation.

Although, in the present embodiment, the operator terminal 2 records a video when detecting a suspicious person, the operator terminal 2 may be configured not to record a video when detecting a suspicious person. In other embodiments, the operator terminal 2 may be configured to always record a video whether or not to detect a suspicious person.

Next, a suspicious person database managed by the operator terminal 2 will be described. FIG. 15 is an explanatory diagram showing records registered in the suspicious person database.

When detecting a suspicious person through face authentication, the operator terminal 2 registers the detected suspicious person in the suspicious person database (suspicious person list). Registered in the suspicious person database are a set of records for each event in which the operator terminal 2 detects a suspicious person, the set of records including a record ID, detection date, detection time, feature information including features of a suspicious person extracted from video data, and a name of file containing the latest video data of the detected suspicious person.

The operator terminal 2 can detect the same person two or more times. In such cases, video data recorded the last time the person was detected as a suspicious person is registered as the newest video data in the suspicious person database. In other embodiments, if the operator terminal 2 detects the same person many times, information on the frequency of detection of a suspicious person may be registered in the suspicious person database.

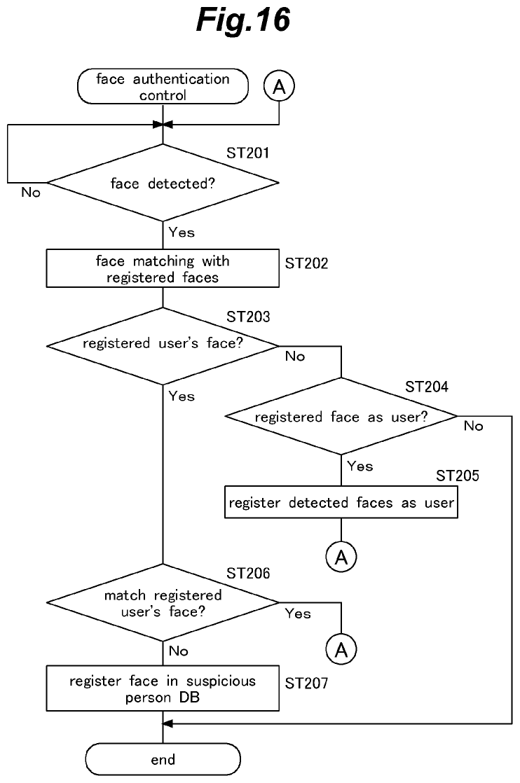

Next, face authentication control operations performed by the operator terminal 2 will be described. FIG. 16 is a flow chart showing an operation procedure of the face authentication control operations.

In the face authentication control, first, the operator terminal 2 performs an operation to detect any person's face from a frontal-face video of the user received from the kiosk terminal 1, and if the operator terminal 2 detects a face (Yes in ST201), the operator terminal 2 performs a matching operation by comparing the detected face with registered faces for matching (ST202). Then, the operator terminal 2 determines whether or not detected faces include a registered user's face (ST203).

If the detected faces do not include the registered user's face (No in ST203), the operator is urged to check a frontal-face video of the user displayed on the first monitor 22 and determine whether or not the user is a new user through visual check. If the operator determines the user is a new user and performs a user registration operation, all detected faces are registered in a user data base (ST205), and then the process returns to ST201.

If the detected faces include a registered user's face (Yes in ST203), the operator terminal 2 determines whether or not each of all the detected faces matches the registered user's face (ST206).

If all the detected faces match the registered user's face (Yes in ST206), and then the process returns to ST201.

If not all the detected faces match the registered user's face; that is, the detected faces include an unregistered users' face(s) (No in ST206), the operator terminal 2 registers the faces which do not match the registered user's faces in the suspicious person database (FIG. 15) (ST207). In other embodiments, the operator terminal 2 may be configured such that the operator is urged to check a frontal-face video of the user displayed on the first monitor 22 and determine if each of the faces is a face of a suspicious person prying into the screen of the kiosk terminal, and if the operator determines a face is a suspicious person's face and performs a suspicious person registration operation, the face is registered as a suspicious person's face in the suspicious person database.

By using the control operations, a person(s) who appears in the frontal-face video of the user from the beginning, the person(s), which can include an accompanying person of the user who operates the kiosk terminal 1, is registered as a user(s), and when a person who is not a registered user appears in the frontal-face video some time after the video begins, the person is detected as a suspicious person. Therefore, in cases where an accompanying person once disappears from the video and then appears again, the accompanying person, who is already registered as a user, will not be detected as a suspicious person.

A face of a user is temporarily registered as a face image at the time when the user starts using the kiosk terminal 1, and the face image is cleared when the user finishes or temporarily stops using the kiosk terminal 1. Thus, a user's privacy is protected.

In other embodiments, the operator terminal may be configured such that, feature information including features of a face of a person detected as a suspicious person is registered in the suspicious person database and the operator terminal detects a suspicious person by performing a face matching operation based on the feature information registered in the suspicious person database.

While specific embodiments of the present invention are described herein for illustrative purposes, the present invention is not limited to the specific embodiments. It will be understood that various changes, substitutions, additions, and omissions may be made for elements of the embodiments without departing from the scope of the invention. In addition, elements and features of the different embodiments may be combined with each other as appropriate to yield an embodiment which is within the scope of the present invention.

### INDUSTRIAL APPLICABILITY

A bidirectional video communication system and an operator terminal according to the present invention achieve an effect of enabling a user to focus on the operation of a kiosk terminal while virtually eliminating any concerns about prying eyes, and are useful as a bidirectional video communication system for bidirectional communication between a kiosk terminal and an operator terminal, the system being configured for bidirectional transmission of a video of a user who operates the kiosk terminal and a video of an operator who operates the operator terminal, and an operator terminal used therein.

### Glossary

1 kiosk terminal
2 operator terminal
12 front-facing monitor
13 upward-facing monitor
14 front-facing camera
15 downward-facing camera
17 speaker
18 microphone
22 first monitor
23 second monitor
24 front-facing camera
25 downward-facing camera
26 headset
28 speaker
29 microphone
31 controller
32 communication device
33 storage
41 controller
42 communication device
43 storage
53 operator's frontal-face video
54 video of operator's hands
62 user's frontal-face video
63 video of user's hands
71 window frame image

1. (canceled)

2. (canceled)

3. A bidirectional video communication system for bidirectional communication between a kiosk terminal and an operator terminal, the system being configured for bidirectional transmission of a video of a user who operates the kiosk terminal and a video of an operator who operates the operator terminal,
wherein the kiosk terminal comprises:
a communication device configured to perform communication with the operator terminal;
a camera configured to shoot a frontal-face video of the user such that the frontal-face video includes a background of the user; and
a controller,
wherein the operator terminal comprises:
a communication device configured to perform communication with the kiosk terminal;
a camera configured to shoot a frontal-face video of the operator;
a monitor configured to display the frontal-face video of the user received from the kiosk terminal; and
a controller,
wherein the controller of the operator terminal is configured such that, upon receiving the frontal-face video of the user shot by the camera of the kiosk terminal, the controller performs face authentication on a person in the frontal-face video of the user, and that, upon detecting a suspicious person through the face authentication, the controller transmits an alert notification message to the kiosk terminal, and
wherein the controller of the kiosk terminal is configured such that, upon receiving the alert notification message, the controller performs a prescribed alert operation.

4. The bidirectional video communication system according to claim 3, wherein the controller of the operator terminal is configured such that, upon detecting a suspicious person through the face authentication, the controller generates a screen in which identification information distinguishably identifying the user and the suspicious person has been added to the frontal-face video of the user, and transmits the screen to the kiosk terminal as the alert notification message, and
wherein the controller of the kiosk terminal is configured to display the screen received from the operator terminal as the alert operation.

5. (canceled)

6. The bidirectional video communication system according to claim 2, wherein the controller of the kiosk terminal is configured to display a character and/or a pictorial figure adapted to give an alert to the user as the alert operation.

7. The bidirectional video communication system according to claim 2, wherein the controller of the kiosk terminal is configured to display a prescribed image in a blinking state on the monitor as the alert operation.

8. The bidirectional video communication system according to claim 4, wherein the controller of the operator terminal is configured to generate, as the identification information, a screen in which a window frame image surrounding a suspicious person in the frontal-face video of the user is superimposed on the frontal-face video of the user.

9. The bidirectional video communication system according to claim 4, wherein the controller of the operator terminal is configured to display the frontal-face video of the user in a horizontally flipped manner.

10. The bidirectional video communication system according to claim 3, wherein the controller of the operator terminal is configured such that, upon detecting a suspicious person through the face authentication, the controller registers the suspicious person on a suspicious person list.

11. An operator terminal for bidirectional communication with a kiosk terminal, the operator terminal being configured for bidirectional transmission of a video of a user who operates the kiosk terminal and a video of an operator who operates the operator terminal to and from the kiosk terminal, the operator terminal comprising:
a communication device configured to perform communication with the kiosk terminal;
a camera configured to shoot a frontal-face video of the operator;
a monitor configured to display the frontal-face video of the user received from the kiosk terminal;
a microphone configured to pick up a sound of the operator's voice; and
a controller, and
wherein the controller is configured such that, upon receiving a frontal-face video of a user shot by a camera of the kiosk terminal such that the frontal-face video includes a background of the user, the controller displays a screen including the frontal-face video of the user on the monitor while performing face authentication on a person in the frontal-face video of the user, and that, upon detecting a suspicious person through the face authentication, the controller generates a screen in which identification information distinguishably identifying the user and the suspicious person has been added to the frontal-face video of the user, and displays the screen on the monitor.

12. An operator terminal for bidirectional communication with a kiosk terminal, the operator terminal being configured for bidirectional transmission of a video of a user who operates the kiosk terminal and a video of an operator who operates the operator terminal to and from the kiosk terminal, the operator terminal comprising:
a communication device configured to perform communication with the kiosk terminal;
a camera configured to shoot a frontal-face video of the operator;
a monitor configured to display the frontal-face video of the user received from the kiosk terminal; and
a controller, and
wherein the controller is configured such that, upon receiving a frontal-face video of a user shot by a camera of the kiosk terminal such that the frontal-face video includes a background of the user, the controller displays a screen including the frontal-face video of the user on the monitor, and that, when the operator confirms that a suspicious person is present in the screen and performs an operation to instruct the controller to give an alert to the user, the controller transmits an alert notification message to the kiosk terminal, thereby causing the kiosk terminal to perform a prescribed alert operation.

13. (canceled)

14. An operator terminal for bidirectional communication with a kiosk terminal, the operator terminal being configured for bidirectional transmission of a video of a user who operates the kiosk terminal and a video of an operator who operates the operator terminal to and from the kiosk terminal, the operator terminal comprising:
a communication device configured to perform communication with the kiosk terminal;
a camera configured to shoot a frontal-face video of the operator;
a monitor configured to display the frontal-face video of the user received from the kiosk terminal; and
a controller, and
wherein the controller is configured such that, upon receiving a frontal-face video of a user shot by a camera of the kiosk terminal such that the frontal-face video includes a background of the user, the controller constantly transmits a screen including the frontal-face video of the user to cause the kiosk terminal to display the screen on a monitor of the kiosk terminal while performing face authentication on a person in the frontal-face video of the user, and that, upon detecting a suspicious person through the face authentication, the controller generates a screen in which identification information distinguishably identifying the user and the suspicious person has been added to the frontal-face video of the user, and causes the kiosk terminal to display the screen on the monitor of the kiosk terminal.
